(19) United States
(12) Patent Application Publication
(10) Pub. No.: US 2015/0213103 A1
(43) Pub. Date: Jul. 30, 2015

(54) COMPUTER SYSTEM AND ASYNCHRONOUS REPLICATION MANAGEMENT METHOD

(71) Applicant: HITACHI, LTD., Chiyoda-ku, Tokyo (JP)

(72) Inventors: Takanori Sato, Tokyo (JP); Tomoaki Kakeda, Tokyo (JP)

(73) Assignee: HITACHI, LTD., Tokyo (JP)

(21) Appl. No.: 14/427,347

(22) PCT Filed: Apr. 18, 2013
(86) PCT No.: PCT/JP2013/061484

§ 371 Date: Mar. 11, 2015

(51) Int. Cl. G06F 17/30; H04L 29/08

(52) U.S. Cl. CPC G06F 17/30578; G06F 17/30371; H04L 67/1097

(57) ABSTRACT

A primary storage system receives, from a host computer, indivisible data which is a group of data indivisible for maintaining consistency and generated in the host computer by executing an application, stores the received indivisible data, transmits a plurality of journals each including a plurality of data pieces generated by dividing the indivisible data into predetermined sizes, to a secondary storage system, and transmits, to a management computer, journal information representing that each of the plurality of journals has been transmitted. The management computer receives the journal information from the primary storage system, determines, based on the journal information, whether all the journals corresponding to the indivisible data have been transmitted to the secondary storage system, and, if a determination result is true, stores a time point when all the journals corresponding to the indivisible data have been transmitted as a data recoverable time point indicating a time point when recoverable data of the indivisible data is stored.

### TECHNICAL FIELD

The present invention relates to asynchronous replication for replicating data from a primary storage system to a secondary storage system asynchronously with writing of the data in the primary storage system.

### BACKGROUND ART

In a computer system executing asynchronous replication, a delay period occurs between writing of data in a primary volume of a primary storage system and completion of replication to a secondary volume of a secondary storage system. In this case, if a failure occurs in the primary storage system and the secondary storage system starts to operate in place of the primary storage system, data having been written in the primary volume during the delay period before the point of occurrence of the failure would be lost, because replication of such data to the secondary volume is riot complete. A person who is in charge of management of the computer system needs to know how long the data is lost daring failure and, to decrease a period of time during which the data might be lost, take necessary measures such as enhancing the performance of a storage system or promising users of the storage system to limit such a period of time within a fixed range. The period of time during which data is lost is herein referred to as a “data loss period”.

PTL 1 discloses a technique for measuring a data loss period for each piece of data called a journal.

According to PTL 1, a primary storage system divides data to be replicated to a secondary storage system into data pieces called journals, and saves them in a primary journal volume. The journals held in the primary journal volume are replicated sequentially in order of generation to a secondary journal volume of the secondary storage system. The journals replicated to the secondary journal volume are then restored sequentially as original data pieces and written in the secondary volume.

According to PTL 1, a time point when a journal is written in the primary journal volume is given to the journal, and a data loss period is calculated by subtracting this time point when the journal is written in the primary journal volume from a time point when replication of the journal to the secondary journal volume is completed or when writing of data restored from the journal in the secondary volume is completed.

### CITATION LIST

### Patent Literature

[PTL 1] JP 2009-193208

### SUMMARY OF INVENTION

### Technical Problem

According to PTL 1, the data loss period is a period of time taken until the replication of data included in a journal to the secondary volume is complete. The data loss period in PTL 1 is a useful index for a person who is in charge of management of the computer system to know a worsening condition of data loss time and determine whether any measure should be taken. For a reason described below, however, the data loss time in PTL 1 cannot be used as an index to promise users of application to limit the data loss period within a fixed range.

In many cases, the data written in the primary volume of the primary storage system is used in an application program (hereinafter referred to as application) that runs on a host computer coupled to the primary storage system. In general, a characteristic of data used in applications is that consistency is only maintained when the entire data is provided, and the consistency would not be maintained when even a portion of data is missing. If such a portion of data is missing, therefore, the entire data has to be discarded to maintain consistency. The data having such a characteristic is herein referred to as “indivisible data”.

A data size of the indivisible data is often longer than a journal size having a fixed length. The indivisible data would be, therefore, divided into a plurality of journals and written, for example, in the primary journal volume of the primary storage system when the indivisible data size is longer than the journal size.

It is assumed that a failure occurs before all the plurality of journals derived from one piece of indivisible data is replicated to the secondary journal volume. In this case, the indivisible data has been partially replicated to the secondary volume. To continue operation of the application in the secondary volume coupled to the secondary storage system after the occurrence of the failure, such partially replicated indivisible data has to be discarded to maintain consistency. When viewed from the standpoint of users of the application, an actual data loss period appears to be a period of time starting from the occurrence of the failure and tracing back to the time point when writing of all journals of the indivisible data is complete. The actual data loss period, therefore, might be longer than the data loss period for each journal in PTL 1. The resulting data loss period in PTL 1 would be an erroneous value and cannot be used to promise the users of the application, for example, that the data loss period is limited within a fixed range.

In view of the above, it is an object of the present invention to provide a technique capable of managing information appropriate for an index indicating a data loss period.

### Solution to Problem

A primary storage system receives, from a host computer, indivisible data which is a group of data indivisible for maintaining consistency and generated in the host computer by executing an application, and stores the received indivisible data. The primary storage system transmits a plurality of journals, each including a plurality of data pieces generated by dividing the indivisible data into predetermined sizes, to a secondary storage system. The primary storage system also transmits, to a management computer, journal information representing that each of the plurality of journals has been transmitted. The management computer receives the journal information from the primary storage system, and determines, based on the journal information, whether all the journals corresponding to the indivisible data have been transmitted to the secondary storage system. If a determination result is true, the management computer stores a time point when all the journals corresponding to the indivisible data have been transmitted as a data recoverable time point indicating a time point when, recoverable data for the indivisible data is stored,

### ADVANTAGEOUS EFFECTS OF INVENTION

With respect to data used in an application, it is possible to manage information (e.g., a time point when data is recovered) capable of being used appropriately as an index indicating a data loss period to maintain consistency in the application.

### BRIEF DESCRIPTION OF DRAWINGS

FIG. 1 is a schematic diagram for explaining a first embodiment.

FIG. 2 illustrates the configuration of a computer system according to the first embodiment.

FIG. 3 illustrates the configuration of a host computer according to the first embodiment.

FIG. 4 illustrates the configuration of a primary storage system according to the first embodiment.

FIG. 5 illustrates the configuration of a secondary storage system according to the first embodiment.

FIG. 6 illustrates the configuration of a management computer according to the first embodiment.

FIG. 7 illustrates the configuration of a stagnated journal number table according to the first embodiment.

FIG. 8 illustrates the configuration of a data loss period table according to the first embodiment.

FIG. 9 is a flowchart illustrating management agent processing according to the first embodiment.

FIG. 10 is a flowchart illustrating journal information transmission processing according to the first embodiment.

FIG. 11 is a flowchart illustrating management processing according to the first embodiment.

FIG. 12 is a flowchart illustrating indivisible data journal number calculation processing according to the first embodiment.

FIG. 13 is a flowchart illustrating data loss period calculation processing according to the first embodiment.

FIG. 14 illustrates the configuration of a data loss period display screen according to the first embodiment.

FIG. 15 illustrates the configuration of a management computer according to a second embodiment.

FIG. 16 illustrates the configuration of a journal hash table according to the second embodiment.

FIG. 17 is a flowchart illustrating management agent processing according to the second embodiment.

FIG. 18 is a flowchart illustrating journal information transmission processing according to the second embodiment.

FIG. 19 is a flowchart illustrating management processing according to the second embodiment.

FIG. 20 is a flowchart illustrating indivisible data tail hash value recording processing according to the second embodiment.

FIG. 21 is a flowchart illustrating data loss period calculation processing according to the second embodiment.

### DESCRIPTION OF EMBODIMENTS

Embodiments will be described below with reference to the accompanying drawings. It is to be understood that the following description of the embodiments is in no way to limit the scope of the invention as defined in the following claims and all elements and combinations thereof as described in the description of the embodiments are not necessarily needed to solve the problem of the invention.

In the following description, an expression such as an “aaa table” may be used to explain information of the present invention, but such information may also be expressed in a data configuration format other than a table. To indicate that the information does not rely on the data configuration format, the “aaa table” or the like may sometimes be referred to as the “aaa information”.

In the description below, a “program” may be used to explain processing as a subject of executing the processing; however, a processor may also be used as a subject of executing processing, because programs are executed by a processor (e.g., a central processing unit (CPU)) to execute determined processing, with a storage resource (e.g., memory) and/or a communication interface apparatus (e.g., port) properly used. Processing explained as being executed by a program as a subject may be considered to be executed by an apparatus including a processor. A hardware circuit executing part or all of the processing of the processor may also be included therein. A computer program from a program source may be installed in the apparatus. The program source may be a program distribution server or a computer-readable storage medium.

### First Embodiment

First, a computer system according to a first embodiment will be described.

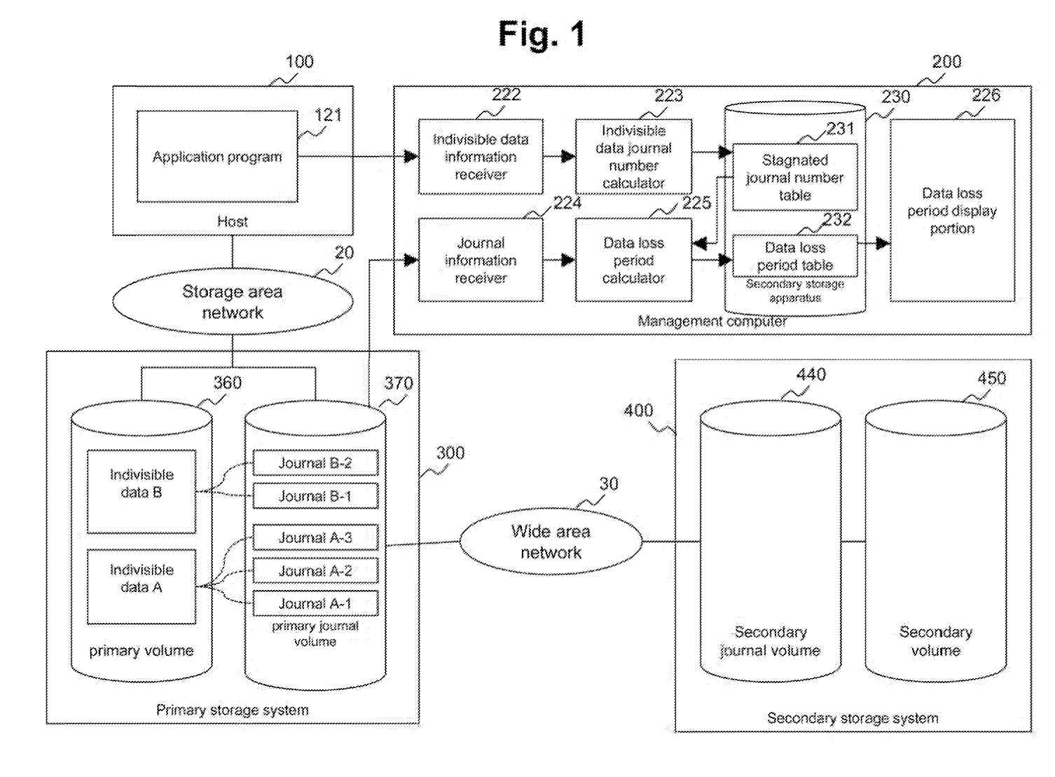

FIG. 1 is a schematic diagram according to the first embodiment.

A host computer 100 executes an application program (application) 121 and stores data (indivisible data A and indivisible data B), to foe used in the application, in a primary volume 360 of a primary storage system 300.

A primary storage system 300 divides the indivisible data stored in the primary volume 360 into journals having predetermined sizes and stores them in a primary journal volume 370. In an example of FIG. 1, the indivisible data is stored in the primary journal volume 370 by dividing the indivisible data A into journals A-1, A-2, and A-3 and dividing the indivisible data B into journals B-1 and B-2. In the computer system of this embodiment, the journals generated from one piece of indivisible data are written in the primary journal volume 370 exclusively. That is, it is guaranteed that ail journals generated from one piece of indivisible data are written in series in the primary journal volume 370.

The primary storage system 300 transmits the journals stored in the primary journal volume 370 sequentially to a secondary storage system 400 via a wide area network 30, The secondary storage system 400 stores the received journals in a secondary journal volume 440.

The secondary storage system 400 sequentially recovers the journals stored in the secondary journal volume 440 into original data portions and writes them into a secondary volume 450. Thus, the data in the primary volume 360 of the primary storage system 300 is replicated to the secondary volume 450 of the secondary storage system 400.

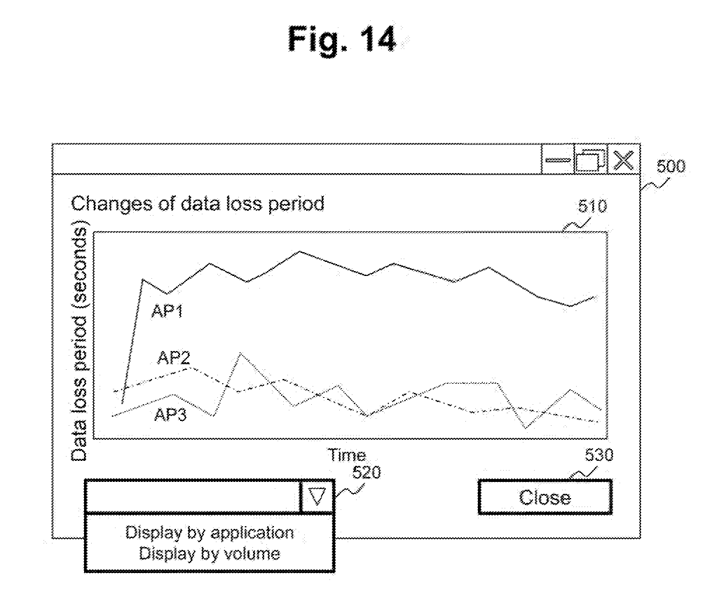

A indivisible data information receiver 222 in a management computer 200 receives, from the host 100, information regarding indivisible data to be written in the primary storage 360 by an application 121 (indivisible data information, such as a complete time point of writing the indivisible data to the primary volume 360 and the size of the indivisible data). Also, a journal information receiver 224 of the management computer 200 receives, from the primary storage system 300, information regarding the transmitted journals (journal information). An indivisible data journal number calculator 223 in the management computer 200 obtains the data size of the indivisible data from the indivisible data information receiver 222, calculates, based on the data size, the number of journals into which the indivisible data is divided, and stores, at the head of a stagnated journal number table 231, the number of journals and the complete time point of writing the indivisible data to the primary volume 360. A data loss period calculator 225 in the management computer 200 receives a notification that the journal information is obtained from the journal information receiver 224, and decrements a value of a stagnated journal number 231b (stagnated journal number) of the tail record in the stagnated journal number table 231 by one. When the stagnated journal number of the record has come to zero, which indicates that ail of the plurality of journals generated by dividing one piece of indivisible data have been transmitted to the secondary storage system 400, the data loss period calculator 225 calculates a data loss period by subtracting, from this time point, the complete time point of writing 231a of the record and stores the value in the data loss period table 232. A data loss period display portion 226 obtains a data loss period from the data loss period table 232, for example, in response to user operation, and displays the information regarding the data loss period on a data loss period information screen 500 (see FIG. 14).

In the computer system of the first embodiment, it is possible to calculate the data loss period for all journals corresponding to the indivisible data based on the time point stored in the secondary storage system 400. Since the data loss period corresponding to the indivisible data matches a period in which data is lost to maintain consistency in the application, such a data loss period is a suitable index for promising users of the application that the data loss period is limited within a fixed period of time.

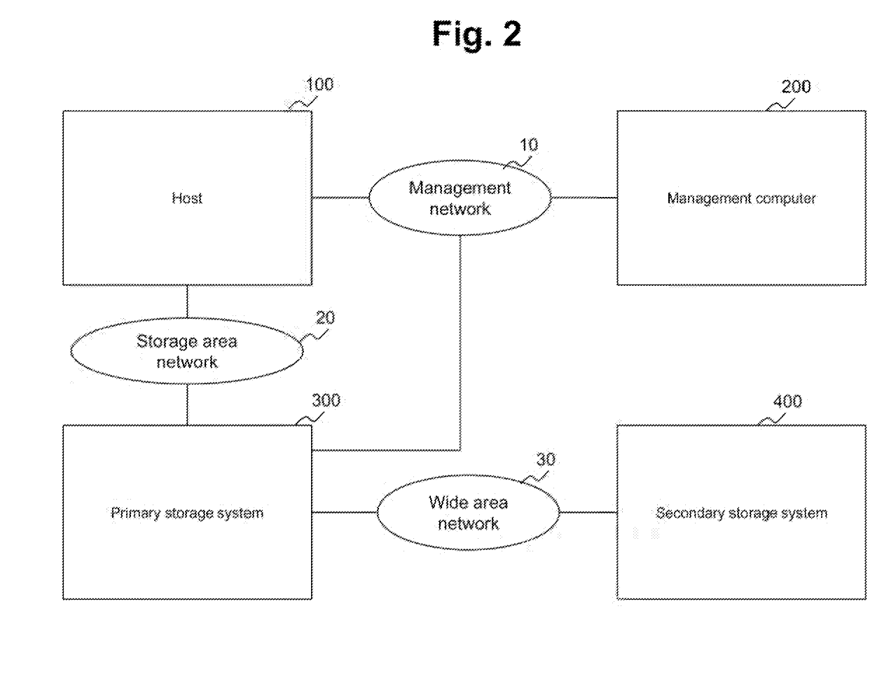

FIG. 2 illustrates the configuration of a computer system according to the first embodiment.

The computer system includes the host computer (hereinafter referred to as host) 100, the management computer 200, the primary storage system 300, and the secondary storage system 400. The host 100, the management computer 200, and the primary storage system 200 are coupled to each other via a management network 10. The host 100 is coupled to the primary storage system 300 via a storage area network (SAN) 20. The primary storage system 300 is coupled to the secondary storage system 400 via a wide area network 30. The wide area network 30 may he formed by, for example, a TCP/IP network or a fiber channel network.

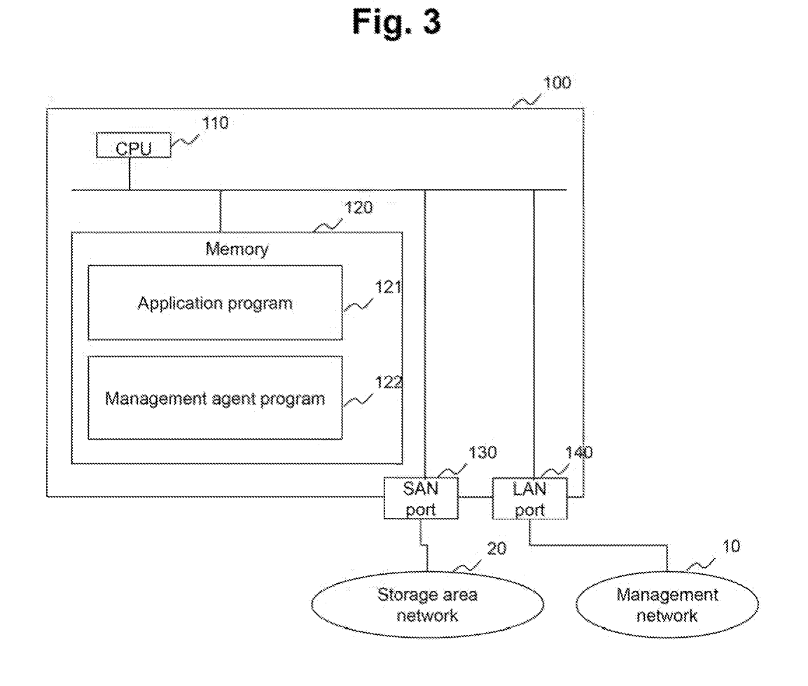

FIG. 3 illustrates the configuration of a host computer according to the first embodiment.

The host 100 includes a central processing unit (CPU) 110, a memory 120, a SAN port 130, and a LAN port 140. The CPU 110 is communicably coupled to the memory 120, the SAN port 130, and the LAN port 140 via an internal bus.

The CPU 110 executes various types of processing by executing various types of programs stored in the memory 120. The memory 120 stores various types of programs and information. In this embodiment, the memory 120 stores the application program (application) 121 and a management agent program 122. The application program 121 carries out predetermined job processing, and writes the resulting data generated by the job processing in the primary volume 360 of the primary storage system 300 (specifically, the host 100 transmits a writing request designating the primary volume 360 to the primary storage system 300). The application program 121 generates data (indivisible data) by assembling indivisible contents for maintaining consistency. The management agent program 122 monitors writing of the indivisible data to the primary volume 360 by the application 121, and notifies the management computer 200 of the indivisible data information. Detailed processing by the management agent program 122 will be described below. The CPU 110 executes the management agent program 122 to form a functional portion equivalent to the management agent portion. The management agent portion may be implemented by separate hardware other than the CPU 110.

The SAN port 130 is an interface device to be used to couple the host 100 to another apparatus via the storage area network 20. The LAN port 140 is an interface device to be used to couple the host 100 to another apparatus via the management network 10.

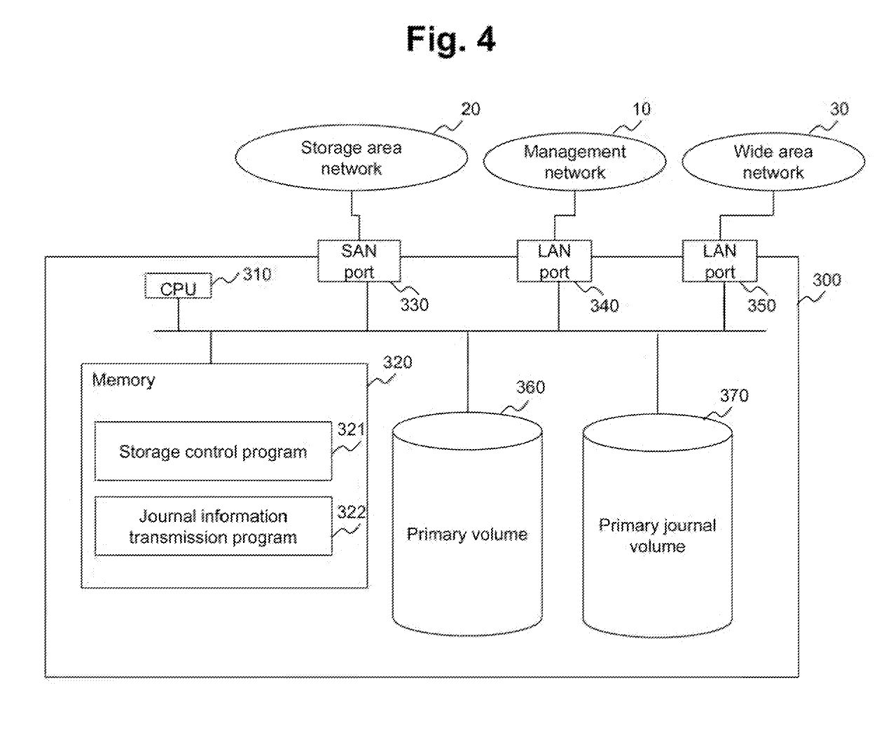

FIG. 4 illustrates the configuration of a primary storage system according to the first embodiment.

The primary storage system 300 includes a CPU 310, a memory 320, a SAN port 330, a LAN port 340, a LAN port 350, the primary volume 360, and the primary journal volume 370. The CPU 310 is communicably coupled to the memory 320, the SAN port 330, the LAN port 340, the LAN port 350, the primary volume 360, and the primary journal volume 370 via an internal bus.

The CPU 310 executes various types of processing by executing various types of programs stored in the memory 320. The memory 320 stores various types of programs and information. In this embodiment, the memory 320 stores a storage control program 321 and a journal information transmission program 322. The storage control program 321 writes data In the primary volume 360 in response to a writing request from the host 100. The storage control program 321 also controls asynchronous replication processing to asynchronously replicate, in the secondary volume 450, the data having been written in the primary volume 360. In the asynchronous replication processing, the storage control program 321 may, for example, write, in the primary journal volume 370, a journal that includes the data (or precisely a replication of the data) having been written in the primary volume 360. The CPU 310 executes the storage control program 321 to form a functional portion equivalent to a storage controller. The storage controller may be implemented by separate hardware other than the CPU 310. The storage control program 321 sequentially retrieves journals from the primary journal volume 370, transmits them to the secondary storage system 400, and deletes the journals from the primary journal volume 370 when the transmission of the journals to the secondary storage system 400 is complete. The journal information transmission program 322 transmits, to the management computer 200, information regarding the journals having been transmitted (journal information). When a journal in the primary journal volume 370 has been erased, that is, when the journal has been transmitted, the journal information transmission program 322 transmits the journal information of the transmitted (erased) journal to the management computer 200. The CPU 310 executes the journal information transmission program 322 to form a functional portion equivalent to a journal information transmitter. The journal information transmitter may be implemented by separate hardware other than the CPU 310.

The SAN port 330 is an interface device to be used to couple the primary storage system 200 to another apparatus (e.g., host 100) via the storage area network 20. The LAN port 340 is an interface device to be used to couple the primary storage system 300 to another apparatus (e.g., management computer 200) via the management network 10. The LAN port 350 is an interface device to be used to couple the primary storage system 300 to another apparatus (e.g., secondary storage system 400) via the wide area network 30.

The primary volume 360 is a volume formed by a storage area of the storage device, such as a hard disk drive (HDD), to store data (e.g., generated data) to be used in the application program 121 in the host 100. The primary journal volume 370 is a volume formed by a storage area of the storage device, such as an HDD, to store a journal corresponding to the data written in the primary volume 360. The journal includes data and management information. The data is a replication of the data having been written in the primary volume 360. The management information includes information regarding the data and includes, for example, a writing destination address (e.g., logical block address (LBA)) of the data in the primary volume 360 and sequential order information (e.g., sequential number or time stamp) identifying the sequential order in which the data has been written.

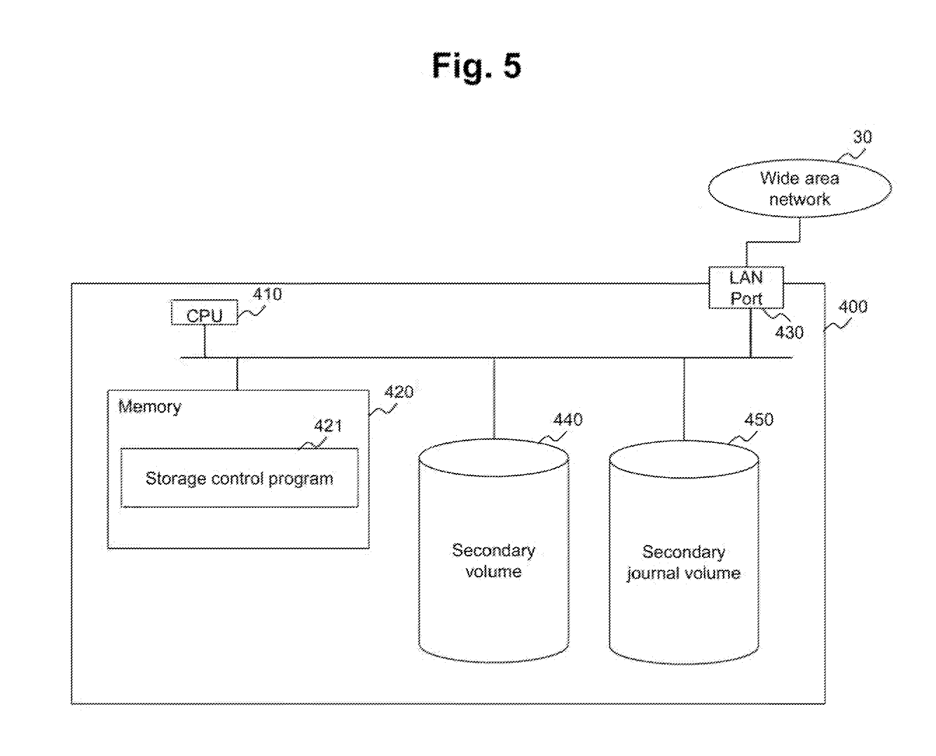

FIG. 5 illustrates the configuration of a secondary storage system according to the first embodiment.

The secondary storage system 400 includes a CPU 410, a memory 420, a LAN port 430, the secondary volume 440, and the secondary journal volume 450. The CPU 410 is communicably coupled to the memory 420, the LAN port 430, the secondary volume 440, and the secondary journal volume 450 via an internal bus.

The CPU 410 executes various types of processing by executing various types of programs stored in the memory 420. The memory 420 stores various types of programs and information. In this embodiment, the memory 420 stores a storage control program 421. The storage control program 421 controls asynchronous replication processing to asynchronously replicate data from the primary volume 360 to the secondary volume 450. Specifically, the storage control program 421, for example, receives a journal transmitted from the primary storage system 300 and stores it in the secondary journal volume 450, while reflecting (writing), among the journals stored in the secondary journal volume 450, data of a journal having not been reflected on the secondary journal volume 450 to the secondary volume 440 in a sequential order specified in the sequential order information of unreflected journals. That is, reflecting the journal is to write journal data of the primary storage system 300 in the secondary volume 440. The journal may be transmitted from the primary storage system 300 to the secondary storage system 400 together with a writing request (replication request) from the primary storage system 300 to the secondary storage system 400, or in response to a reading request (journal request) from the secondary storage system 400 to the primary storage system 300.

The LAN port 430 is an interface device to be used to couple the secondary storage system 400 to another apparatus (e.g., primary storage system 300) via the wide area network 30.

The secondary volume 440 is a volume formed by a storage area of the storage device, such as an HDD, to store a replicate of the data (replicate data) of the primary volume 360. The secondary journal volume 450 is a volume formed by a storage area of the storage device, such as an HDD, to store journals transmitted from the primary storage system 300.

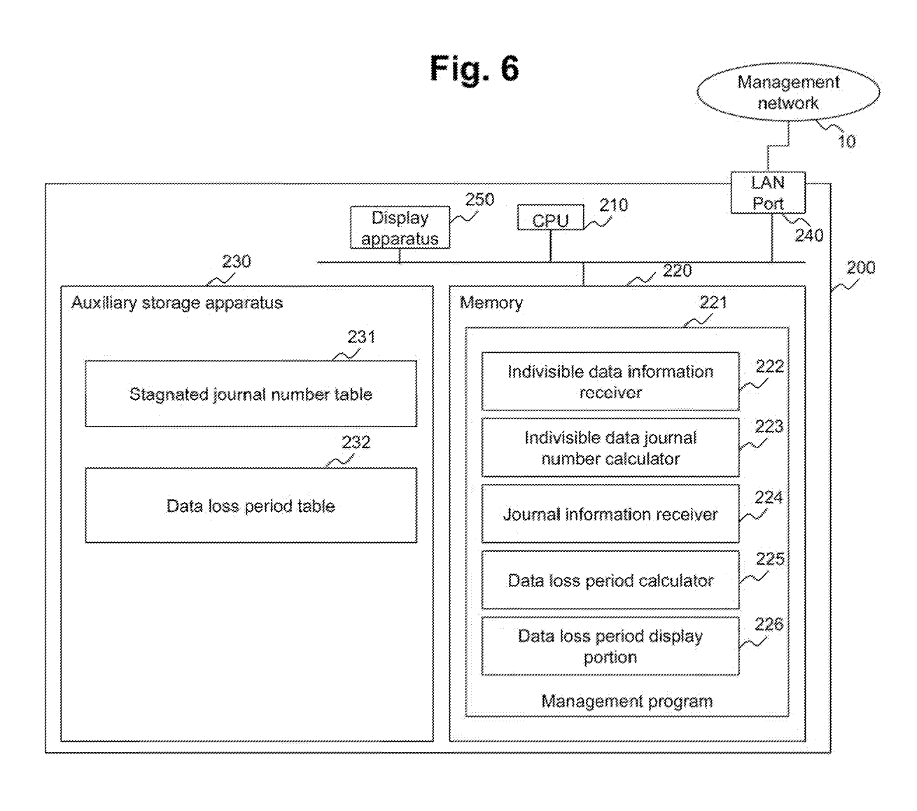

FIG. 6 illustrates the configuration of a management computer according to the first embodiment.

The management computer 200 includes a CPU 210, a memory 220, an auxiliary storage apparatus 230, a LAN port 240, and a display apparatus 250. The CPU 210 is communicably coupled to the memory 220, the auxiliary storage apparatus 230, the LAM port 240, and the display apparatus 250.

The CPU 210 executes various types of processing by executing various types of programs stored in the memory 220. The memory 220 stores various types of programs and information. In this embodiment, the memory 220 stores a management program 221. The CPU 210 executes a program module included in the management program 221 to form functional portions including an indivisible data information receiver 222, an indivisible data journal number calculator 223, a journal information receiver 224, a data loss period calculator 225, and a data loss period display portion 226. A processing operation of each functional portion in the management program 221 will be described below. In this embodiment, the CPU 210 executes a program module included in the management program 221 to form the functional portions including the indivisible data information receiver 222, the indivisible data journal number calculator 223, the journal information receiver 224, the data loss period calculator 225, and the data loss period display portion 226, but the present invention is not limited thereto and at least a part of the functional portions may be implemented by separate hardware other than the CPU 210.

The auxiliary storage apparatus 230 is a storage device, such as an HDD, to store various types of information. In this embodiment, the auxiliary storage apparatus 230 stores a stagnated journal number table 231 and a data loss period table 232. Details of the tables will be described below.

The LAN port 240 is an interface device to be used to couple the management computer 200 to another apparatus (e.g., host 100 and primary storage system 300) via the management network 10. The display apparatus 250 is a display apparatus, such as a liquid crystal display, to display various types of information.

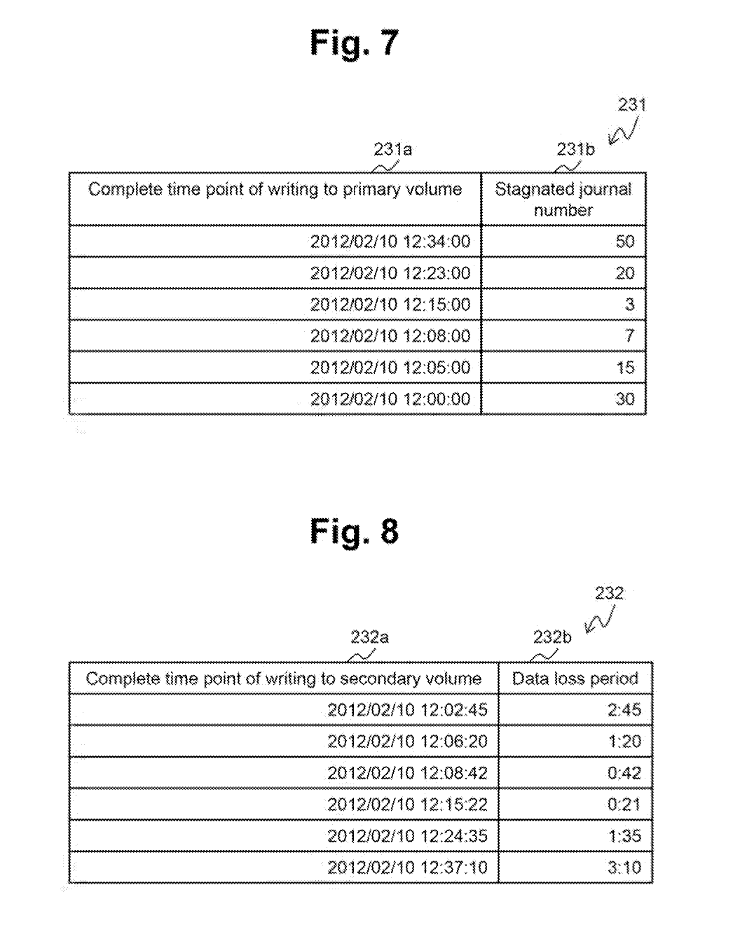

FIG. 7 illustrates the configuration of a stagnated journal number table according to the first embodiment.

The stagnated journal number table 231 stores, for each indivisible data, an entry having fields (columns) of a complete time point of writing to the primary volume 231a and a stagnated journal number 231b.

The complete time point of writing to the primary volume 231a stores a time point (or an equivalent time point) when the writing of the indivisible data corresponding to an entry to the primary volume 360 is complete. The stagnated journal number 231b stores the number of journals (stagnated journal number) that are left (stagnated) without being transmitted to the secondary storage system 400 among the journals ox the indivisible data corresponding to an entry.

FIG. 3 illustrates the configuration of a data loss period table according to the first embodiment.

The data loss period table 232 stores, for each indivisible data, an entry having fields (columns) of a complete time point of writing to the secondary volume 232a and a data loss period 232b.

The complete time point of writing to the secondary volume 232a stores a time point (or equivalent time point) when the writing of all journals of the indivisible data corresponding to an entry in the secondary storage system 400 is complete. The time point when the writing of all the journals in the secondary storage system 400 is complete is equivalent to a data recoverable time point indicating a time point when recoverable data of the indivisible data (application data) is stored. The data loss period 232b stores a period of time (data loss period) when the indivisible data is lost if a failure occurs during replication of the indivisible data corresponding to an entry.

Next, a processing operation of the computer system according to the first embodiment will be described.

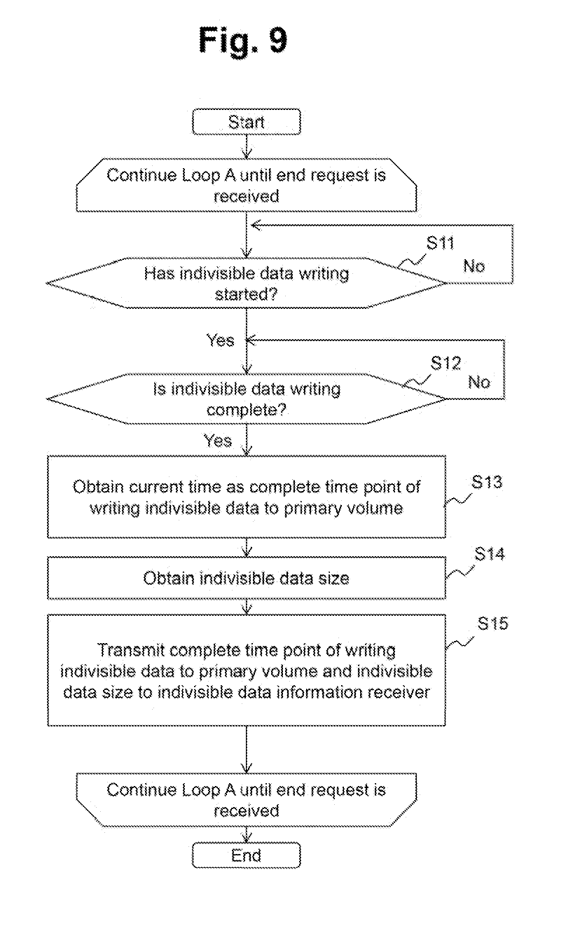

FIG. 9 is a flowchart illustrating management agent processing according to the first embodiment.

The management agent processing is executed by the management agent program 122 in the host 100.

The management agent program 122 executes loop & processing (steps S11 to S15) repeatedly until an end request of processing is received from a management person via a management terminal which is not shown.

First, the management agent program 122 determines whether the writing of the indivisible data is started in the application program 121 (step S11), and when the writing of the indivisible data is not started yet (step S11: No), step S11 is repeated.

Meanwhile, when the writing of the indivisible data is started (step S11: Yes), the management agent program 122 determines whether the writing of the indivisible data is complete in the application program 121 (step S12).

Specifically, the determination as to whether the writing of the indivisible data is complete is carried out in the application program 121 as described below.

First, an example where the application program 121 is an application program using a database system will be described. In this case, when the application program 121 uses a database system, all data to be updated during transactions is indivisible data. The data to be updated during transactions may be, for example, data used in an online shopping application in which a set of data including withdrawal data of the price of merchandise and data of purchase of merchandise are provided. If one of the set of data is lost, the other data should also be erased to maintain consistency of a commercial transaction.

First, the management agent program 122 periodically monitors a transaction log that is output from the database system and obtains a transaction number of a recently committed transaction by referring to a commit record in the transaction log.

Next, the management agent program 122 detects whether the obtained transaction number is different from the last transaction number obtained and stored in the past. When the obtained transaction number is different from the last transaction number stored, the management agent program 122 determines an occurrence of new indivisible data, or determines that the writing of the previous indivisible data is complete. The management agent program 122 stores the obtained transaction number as a new last transaction number. When defecting a difference between the obtained transaction number and the last transaction number stored, the management agent program 122 obtains all update records having occurred between a commit corresponding to the obtained transaction number and a preceding commit, and adds up the capacities of the records to store the result as a data size of the indivisible data (indivisible data size). Thus, it is possible to properly determine whether the writing of the indivisible data is complete when the application program 121 uses a database system.

Next, an example of the application program 121 that is an application program using a file system running on the OS such as Linux® will be described. When the application program 121 uses a file system, a file on the file system is indivisible data. The file on the file system includes metadata that stores information regarding the file itself, such as the size of the file, and actual data indicating the contents of the file. When even a portion of the actual data of the file is lost, inconsistency occurs between the metadata and the actual data and it is impossible to maintain consistency of the entire file system, and the file system erases the entire file. Similarly, when the metadata of the file is lost, the file system is not able to recognize the file, leading to a state similar to the case where the entire file has been erased.

The management agent program 122 detects a write system call of the OS and stores, as a set, a file descriptor indicating the file designated in the call and a writing amount of the file. When the file descriptor is already stored, the management agent program 122 adds a writing amount corresponding to the call this time to the writing amount stored as a set with the file descriptor.

Next, the management agent program 122 detects a close system call of the OS and stores, as the indivisible data size, a writing amount stored as a set with the file descriptor designated in the call. An indication of executing sync command is, then, provided to the OS and the data (indivisible data) cached on the memory 120 is reflected on the primary volume 360 of the primary storage system 300.

The management agent program 122 detects a time point when the execution of the sync command is ended to determine that the writing of the indivisible data is complete. Thus, it is possible to properly determine whether the writing of the indivisible data is complete in the case where the application program 121 is an application program using a file system.

In step S12, when it is not determined that the writing of the indivisible data is complete in the application program 121 (stop S12: No), the management agent program 122 repeats step S12.

Meanwhile, when it is determined that the writing of the indivisible data is complete in the application program 121 (step S12: Yes), the management agent program 122 obtains current time point and regards this time point as a complete time point of writing the indivisible data to the primary volume 360 (Step S13).

Next, the management agent program 122 obtains the stored indivisible data size (step S14) and transmits, to the indivisible data information receiver 222 in the management computer 200, indivisible data information including the complete time point of writing the indivisible data to the primary volume 360 and the indivisible data size (step S15).

By the management agent processing, the indivisible data information regarding each indivisible data of the application program 121 is transmitted to the management computer 200.

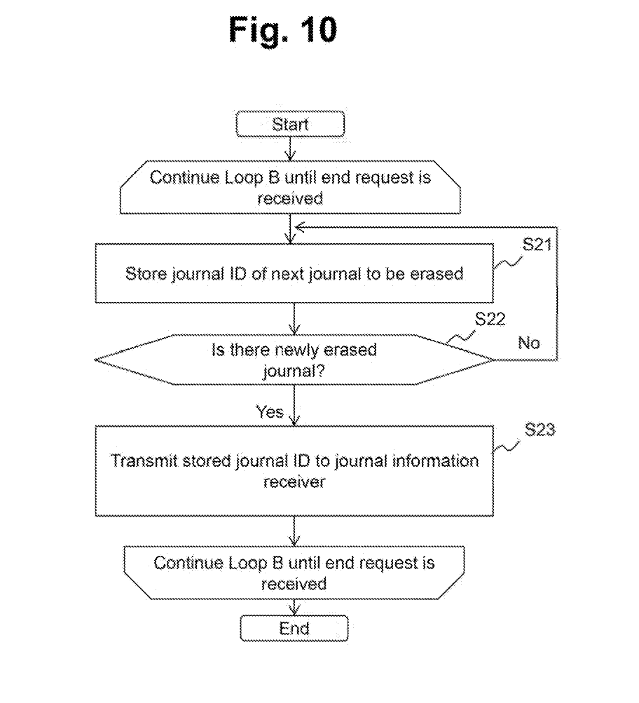

FIG. 10 is a flowchart illustrating journal information transmission processing according to the first embodiment.

The journal information transmission processing is executed by the journal information transmission program 322 in the primary storage system 300.

The journal information transmission program 322 executes loop B processing (steps S21 to S23) repeatedly until an end request of processing is received from a management person via a management terminal.

First, the journal information transmission program 322 stores a journal ID of a next journal to be erased (a next journal to be transmitted to the secondary storage system 400) in the primary journal volume 370 (step S21). When no journal is stored in the primary journal volume 370, no action is taken in the journal information transmission program 322.

Next, the journal information transmission program 322 determines whether the journal having the stored journal ID has been erased from the primary journal volume 370 (step S22). Accordingly, when the journal having the stored journal ID has not been erased from the primary journal volume 370 (step S22: No), the journal information transmission program 322 proceeds to step 321.

Meanwhile, when the journal having the stored journal ID has been erased from the primary journal volume 370 (step S22: Yes), which indicates that the storage control program 321 has deleted, from the primary journal volume 370, a journal having the journal ID by transmitting it to the secondary storage system 400, the journal information transmission program 322 transmits the journal information including the stored journal ID to the journal information receiver 224 in the management computer 200 (step S23). Thus, it is possible to properly determine that the journal has been transmitted to the secondary storage system 400 and properly transmit the journal information corresponding to the journal to the management computer 200.

By the journal information transmission processing, the journal information including the journal ID of each journal having been transmitted to the secondary storage system 400 is transmitted to the management computer 200.

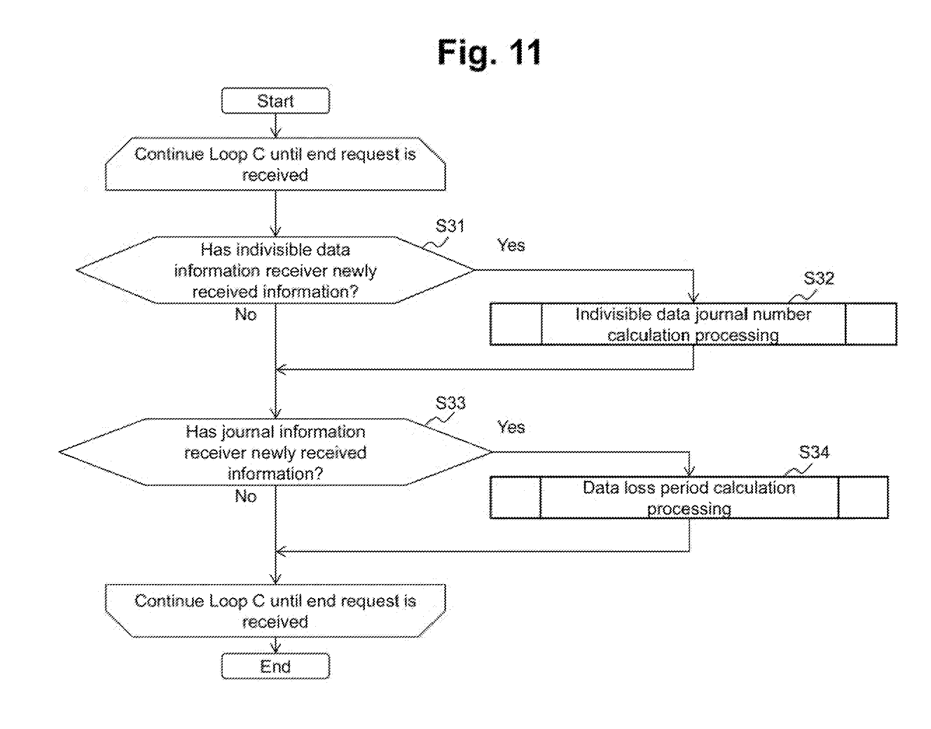

FIG. 11 is a flowchart illustrating management processing according to the first embodiment.

The management processing is executed by the management program 221 in the management computer 200.

The management program 221 executes loop C processing (steps S31 to S34) repeatedly until an end request of processing is received from a management person via a management terminal.

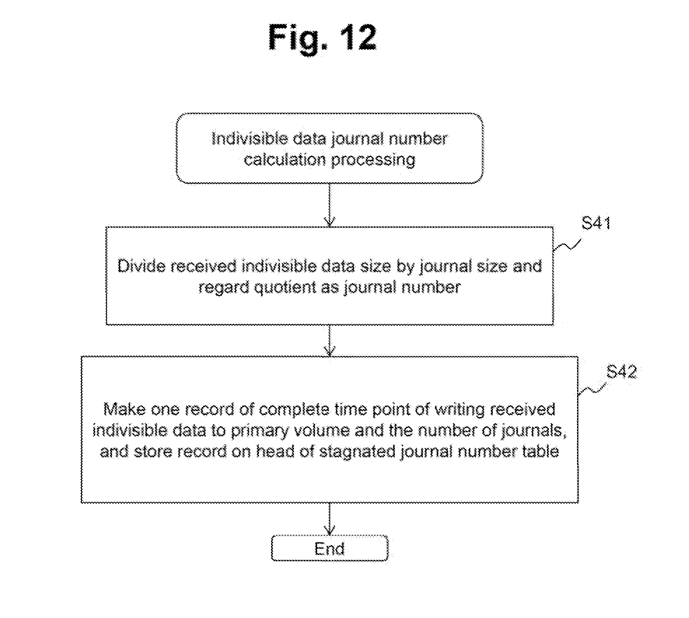

First, the management program 221 determines whether the indivisible data information receiver 222 has newly received indivisible data information (step S31). Accordingly, when the indivisible data information receiver 222 has newly received the indivisible data information (step S31: Yes), the indivisible data journal number calculation processing (see FIG. 12) is executed by the indivisible data journal number calculator 223 in the management program 221 (step S32). In the indivisible data journal number calculation processing, the number of journals generated based on the indivisible data is calculated and registered in the stagnated journal number table 231.

Meanwhile, when the indivisible data information receiver 222 has not newly received indivisible data information (step S31: No), or when the indivisible data journal number calculation processing is ended, the management program 221 determines whether the journal information receiver 224 has newly received the journal information (step S33).

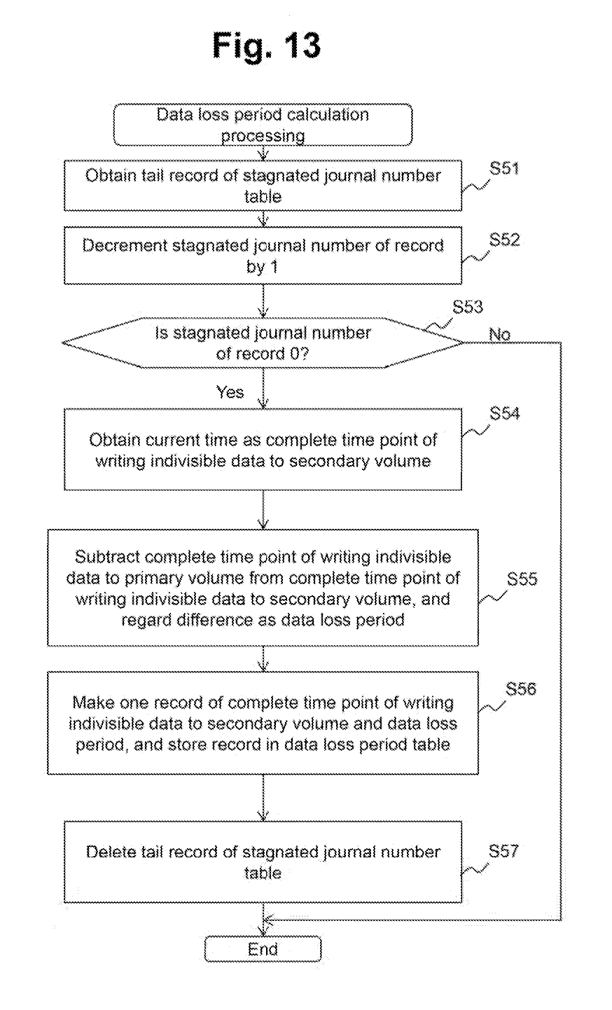

Accordingly, when it is determined that the journal information receiver 224 has newly received the journal information (step S33: Yes), data loss period calculation processing (see FIG. 13) is executed by the data loss period calculator 225 in the management program 221 (step S34).

Meanwhile, when the journal information receiver 224 has not newly received the journal information (step S33: No), or when the data lose period calculation processing is ended, the management program 221 proceeds to step S31.

FIG. 12 is a flowchart illustrating indivisible data journal number calculation processing according to the first embodiment.

The indivisible data journal number calculation processing corresponds to step S32 of FIG. 11 and is executed by the indivisible data journal number calculator 223 of the management program 221 in the management computer 200.

First, the indivisible data journal number calculator 223 calculates the number of journals (journal number) to be generated based on the indivisible data by dividing, by a predetermined journal size (journal size), the indivisible data size in the indivisible data information received by the indivisible data information receiver 222 (step S41).

Next, the indivisible data journal number calculator 223 makes a record of a time point when the writing of the indivisible data of the received indivisible data information in the primary volume 360 is complete and a calculated journal number, adds the record to the head of the stagnated journal number table 231 (step S42), and then ends the processing.

By the indivisible data journal number calculation processing, it is possible to register, in the stagnated journal number table 231, the journal number of the indivisible data having been newly written in the primary volume 360.

FIG. 13 is a flowchart illustrating data loss period calculation processing according to the first embodiment.

The data loss period calculation processing corresponds to step S34 of FIG. 11 and is executed by the data loss period calculator 225 in the management computer 200.

First, the data loss period calculator 225 obtains the tail record of the stagnated journal number table 231 (step S51) and decrements the stagnated journal number of the record by one in the stagnated journal number 231b (step S52).

Next, the data loss period calculator 225 determines whether the stagnated journal number of the record has come to zero (step S53).

When the resulting stagnated journal number of the record is not zero (step S53: No), which indicates that the transmission of all journals of the indivisible data corresponding to the record to the secondary storage system 400 is not completed, the data loss period calculator 225 then ends the processing.

Meanwhile, when the stagnated journal number of the record is zero (step S53: Yes), which indicates that the transmission of all journals of the indivisible data corresponding to the record to the secondary storage system 400 is complete, the data loss period calculator 225 regards current time point at this time point as a complete time point of writing the indivisible data to the secondary volume 450 (step S54).

Next, the data loss period calculator 225 subtracts, from the complete time point of writing the indivisible data to the secondary volume 450, the complete time point of writing the indivisible data to the primary volume 360, which has been stored in the complete time point of writing to the primary volume 231a of the record obtained from the stagnated journal number table 231, and regards the obtained time period as a data loss period for the indivisible data (step S55).

Next, the data loss period calculator 225 generates a record including the complete time point of writing the indivisible data to the secondary volume and the data loss period, adds the record to the data loss period table 232 (step S56), deletes the tail record of the stagnated journal number table 231 (step S57), and ends the processing.

In the data loss period calculation processing, it is possible to properly determine, based on the transmitted journal number, that all journals corresponding to the indivisible data have been transmitted. It is also possible to accumulate, in the data loss period table 232, the complete time point of writing the indivisible data to the secondary volume and the data loss period of each indivisible data. Thus, it is possible to understand the complete time point of writing the indivisible data to the secondary volume and the data loss period of each indivisible data.

FIG. 14 illustrates the configuration of a data loss period display screen according to the first embodiment.

A data loss period display screen 500 is an exemplary screen on the display apparatus 250 displaying the data loss period display portion 226 of the management computer 200 based on the data loss period table 232.

The data loss period display screen 500 includes a changes of data loss period display area 510, a display unit selection area 520, and a close button 530.

The changes of data leas period display area 510 is an area for displaying changes of the data loss period in a display unit selected in the display unit selection area 520. The changes of data loss period display area 510 displays, from the data loss period display portion 226 based on the data loss period table 232, a graph (e.g., line graph), for example, in which the abscissa indicates the complete time point of writing the indivisible data to the secondary volume and the ordinate indicates the data loss period. The display unit may be, for example, a volume unit for displaying a single line using the indivisible data stored in a primary volume 360 as a unit, an application unit for displaying a single line using the indivisible data regarding an application as a unit, or a replication group unit for displaying a single line using the indivisible data related to a plurality of volumes belonging to a single replication group as a unit. In the example of FIG. 14, the changes of data loss period display area 510 shows a graph of the data loss period of the indivisible data regarding each application of the applications AP1, AP2, and AP3 when the application unit display is designated.

To perform display in a volume unit, the management agent program 122 needs to obtain an ID of the primary volume, in which the indivisible data has been written, and transmit the indivisible data information, by adding the primary volume ID thereto, to the management program 221 in the management computer 200. It is also necessary to add a column to manage the corresponding primary volume ID to each record of the stagnated journal number table 231 and the data loss period table 232 in the management computer 200. The management program 211 has to store the primary volume ID included in the indivisible data information in the stagnated journal number table 231 and the data loss period table 232. The data loss period display portion 226 displays a graph indicating, as a single line, the data loss period of the indivisible data associated with the same primary volume ID. By performing display in a volume unit in this manner, a primary volume having a particularly worsening data loss period can be identified easily.

To perform display in an application unit, the management agent program 122 needs to obtain an ID of the application, In which the indivisible data has been written, and an ID of the primary volume in which the writing has been carried out, and transmit the indivisible data information, by adding the application ID and the primary volume ID thereto, to the management program 221 in the management computer 200. It is also necessary to add a column to manage the corresponding application ID to each record of the stagnated journal number table 231 and the data loss period table 232 in the management computer 200. The management program 211 needs to store the application ID included in the indivisible data information in the stagnated journal number table 231 and the data loss period table 232. The management program 211 also needs to obtain in advance a relation between the application ID of the application and a volume ID of the volume being used by the application. The relation may be obtained, for example, from the input by a management person. Accordingly, the data loss period display portion 226 displays a graph indicating, as a single line, the data loss period regarding the indivisible data associated with the same application ID. By performing display in an application unit in this manner, an application having a particularly worsening data loss period can be identified easily.

The display unit selection area 520 is an area, for receiving, from a management person, a selected display unit to be displayed in the changes of data loss period display area 510. The close button 530 is a button for receiving, from a management person, an indication to close the data loss period display screen 500.

Next, a computer system according to the second embodiment will be described.

The computer system according to the second embodiment is configured such that the complete time point of writing each indivisible data to the secondary volume can be identified and the data loss period for indivisible data can be properly calculated, even when it is not guaranteed that journals generated from one piece of indivisible data are exclusively written without fail in the primary journal volume 370, that is, even when journals generated from a plurality of indivisible data pieces are mixed and written in the primary journal volume 370.

The configuration of the computer system according to the second embodiment is basically similar to that of the computer system according to the first embodiment shown in FIG. 2. The following description, therefore, will focus on a difference from the computer system of the first embodiment.

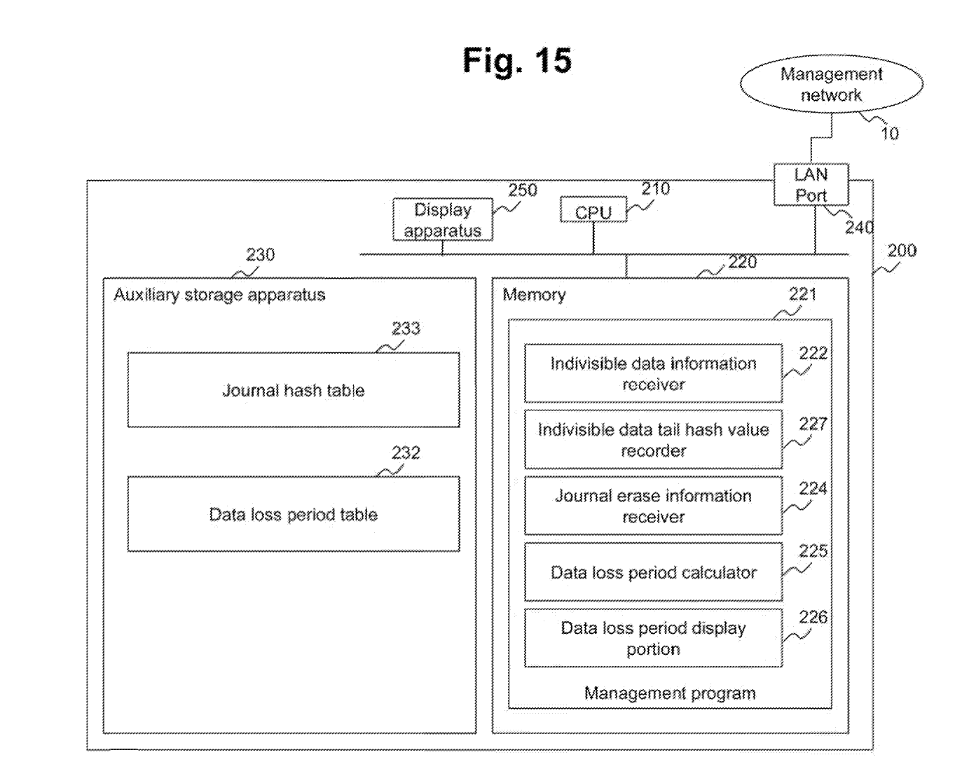

FIG. 15 illustrates the configuration of a management computer according to the second embodiment. Constituent elements similar to those in the management computer of the first embodiment are indicated by the same reference numerals.

An auxiliary storage apparatus 230 of the management computer 200 of the second embodiment stores a journal hash table 233 instead of the stagnated journal number table 231 of the first embodiment. Details of the journal hash table 233 will be described below. The management program 221 in the management computer 200 of the second embodiment includes an indivisible data tail hash value recorder 227 instead of the indivisible data journal number calculator 223 of the first embodiment. Details of the processing carried out by the indivisible data tail hash value recorder 227 will be described below.

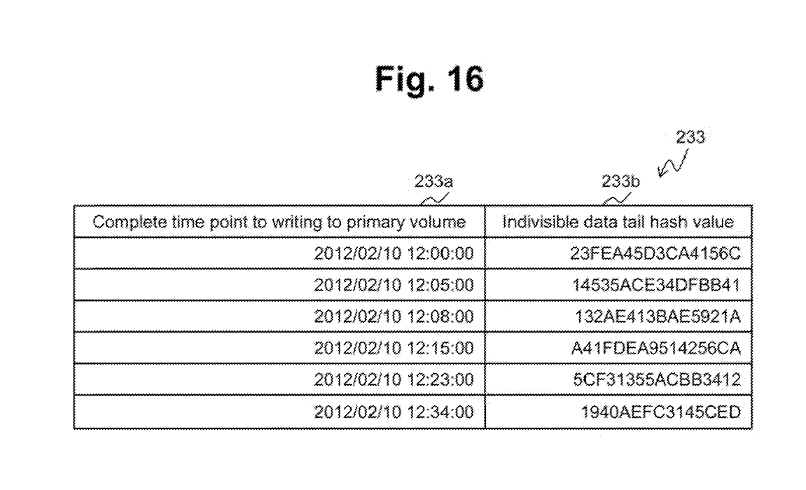

FIG. 16 illustrates the configuration of a journal hash table according to the second embodiment.

The journal hash table 233 stores entries including, for each indivisible data, a field having a complete time point of writing to the primary volume 233a and an indivisible data tail hash value 233b.

The complete time point of writing to the primary volume 233a stores a time point when the writing, to the primary volume 360, of the indivisible data corresponding to an entry is completed. The indivisible data tail hash value 233b stores a hash value based on the indivisible data corresponding to an entry, in which the hash value is a basis of the tail journal in a plurality of journals generated based on the indivisible data corresponding to the entry.

Next, a processing operation of the computer system according to the second embodiment will be described.

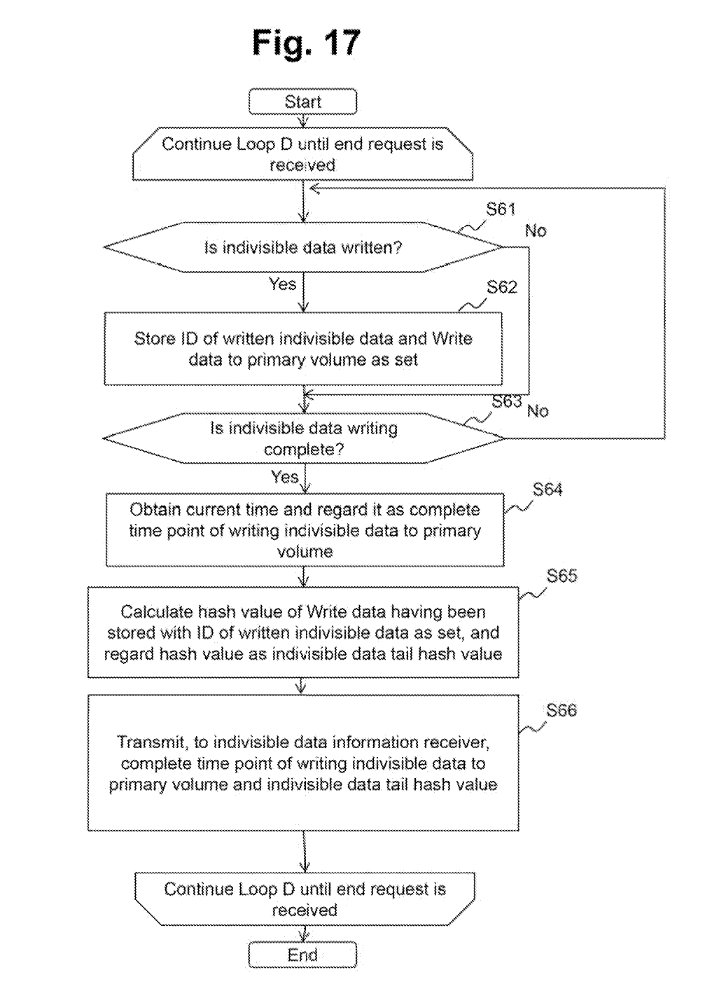

FIG. 17 is a flowchart illustrating management agent processing according to the second embodiment.

The management agent processing is executed by the management agent program 122 in the host 100.

The management agent program 122 executes loop D processing (steps S61 to S66) repeatedly until an end request of processing is received from a management person via a management terminal.

First, the management agent program 122 determines whether indivisible data has been written in the application program 121 (step S61), and when the writing of the indivisible data has not been carried cut (step S61: No), proceeds to step S63.

Meanwhile, when the writing of the indivisible data has been carried out (step S61: Yes), the management agent program 122 stores, as a set, identification information (ID) of the written indivisible data and writing data (Write data) that is a predetermined unit in the indivisible data used to write in the primary volume 360 (step S62). In the primary storage system 300 of this embodiment, a journal is generated corresponding to the Write data. In step S62, when the set of the written indivisible data ID has already been stored, the management agent program 122 deletes the set. Accordingly, a set of the written indivisible data ID and the last Write data transmitted in the end of the indivisible data is stored.

In step S63, the management agent program 122 determines whether the writing of the entire indivisible data is complete (step S63). Determination as to whether the writing of the indivisible data is complete in the application program 121 can be realized by a method similar to that of the first embodiment.

Accordingly, when it is not determined that the writing of the indivisible data is complete in the application program 121 (step S63: No), the management agent program 122 proceeds to step S61.

Meanwhile, when it is determined that the writing of the indivisible data is complete in the application program 121 (step S63: Yes), the management agent program 122 obtains current time point at this time point and regards it as a complete time point of writing the indivisible data to the primary volume (Step S64).

Next, the management agent program 122 calculates a hash value corresponding to the Write data having been stored as a set with the ID of the indivisible data having been, written, and regards the hash value as an indivisible data, tail hash value (step S65). The Write data stored as a set with the indivisible data ID, with the writing of the indivisible data being complete, is a basis of the tail journal for the indivisible data (tail Write data).

Next, the management agent program 122 transmits, to the indivisible data information receiver 222 in the management computer 200, the indivisible data information including the complete time point of writing the indivisible data to the primary volume and the indivisible data tail hash value (step S66).

By the management agent processing, the indivisible

data information including the indivisible data ID for indivisible data in the application program 121 and the tail Write data hash value of the indivisible data is transmitted to the management computer 200.

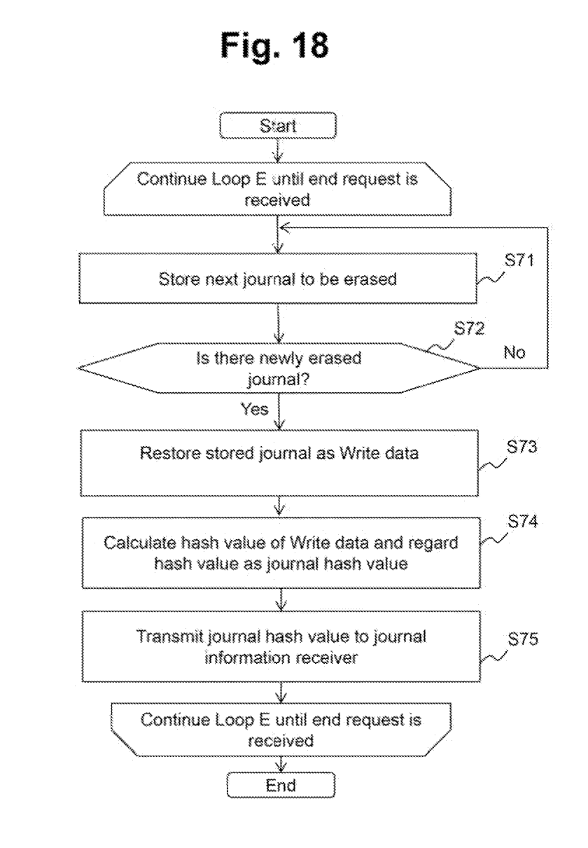

FIG. 18 is a flowchart illustrating journal information transmission processing according to the second embodiment.

The journal Information transmission processing is executed by the journal information transmission program 322 in the primary storage system 300.

The journal information transmission program 322 executes loop E processing (steps S71 to S75) repeatedly until an end request of processing is received from a management person via a management terminal.

First, the journal information transmission program 322 stores a next journal to be erased (a next journal to be transmitted to the secondary storage system 400) in the primary journal volume 370 (step S71). When no journal la stored in the primary journal volume 370, no action is taken by the journal information transmission program 322.

Next, the journal information transmission program 322 determines whether the stored journal has been erased from the primary journal volume 370 (step S72). Accordingly, when the stored journal has not been erased from the primary journal volume 370 (step S72: No), the journal information transmission program 322 proceeds to step S71.

Meanwhile, when the stored journal has been erased from the primary journal volume 370 (step S72: Yes), the journal information transmission program 322 restores the stored journal as the Write data (step S73), and calculates a hash value of the restored Write data to be used as a journal hash value (step S74).

Next, the journal information transmission program 322 transmits, to the journal information receiver 224 in the management computer 200, the journal information including the journal hash value (step S75).

By the journal information transmission processing, the journal information including the hash value of the Write data, which is a basis of the journal transmitted to the secondary storage system 400, is transmitted to the management computer 200.

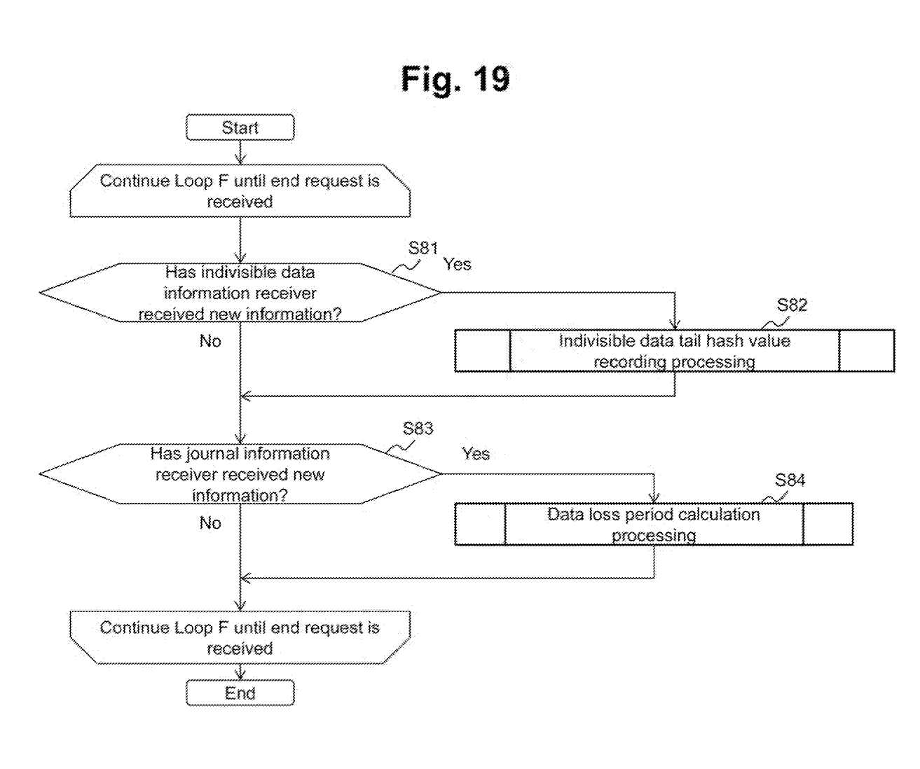

FIG. 19 is a flowchart illustrating management processing according to the second embodiment.

The management processing is executed by the management program 221 in the management computer 200.

The management program 221 executes loop F processing (steps S81 to S84) repeatedly until an end request of processing is received from a management person via a management terminal.

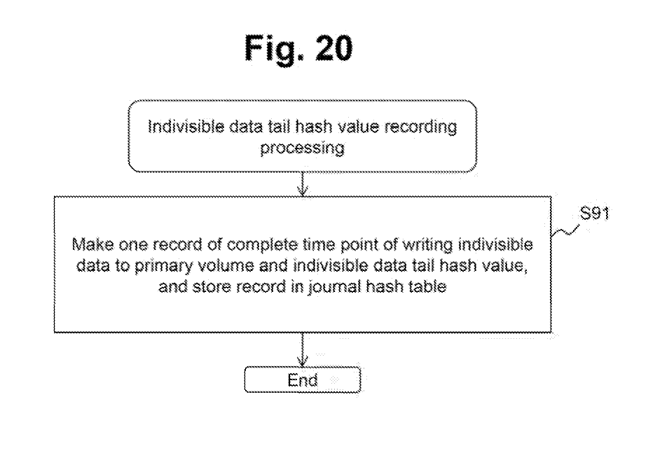

First, the management program 221 determines whether the indivisible data information receiver 222 has newly received the indivisible data information (step S81). Accordingly, when the indivisible data information receiver 222 has newly received the indivisible data information (step S81: Yes), the indivisible data tail hash value recording processing is executed by the indivisible data tail hash value recorder 227 (see FIG. 20) in the management program 221 (step S82). By the indivisible data tail hash value recording processing, the tall hash value of the Write data of the indivisible data is registered in the journal hash table 233.

Meanwhile, when the indivisible data information receiver 222 has not newly received the indivisible data information (step S81: No), or when the indivisible data tail hash value recording processing is ended, the management program 221 determines whether the journal information receiver 224 has newly received the journal information (step S83).

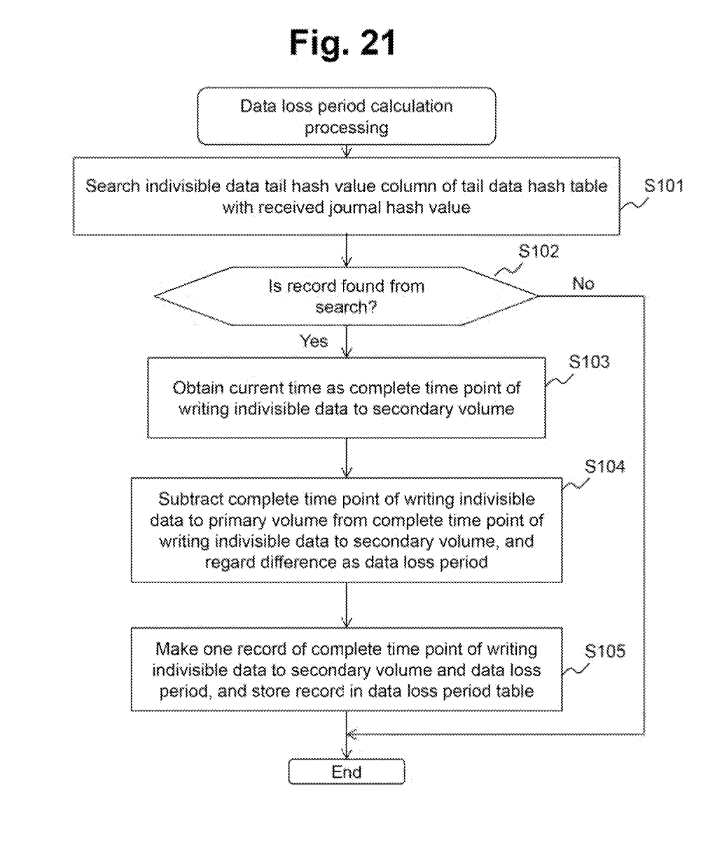

Accordingly, when the journal information receiver 224 has newly received the journal information (step S83: Yes), the data loss period calculation processing (see FIG. 21) is executed by the data loss period calculator 225 in the management program 221 (step S84).

Meanwhile, when the journal information receiver 224 has not newly received the journal information (step S83: No), or the data loss period calculation processing is ended, the management program 221 proceeds to step S81.

FIG. 20 is a flowchart illustrating indivisible data tail hash value recording processing according to the second embodiment.

The indivisible data tail hash value recording processing corresponds to step S82 of FIG. 19 and is executed by the indivisible data tail hash value recorder 227 in the management computer 200.

First, the indivisible data tail hash value recorder 227 generates a record including a complete time point of writing, when the indivisible data in the indivisible data information received by the indivisible data information receiver 222 is written in the primary volume 360 and an indivisible data tail hash value, adds the record to the journal hash table 233 (step S91), and ends the processing.

By the indivisible data tail hash value recording processing, it is possible to register, in the journal hash table 233, the hash value of the tail Write data of the indivisible data having been newly written in the primary volume 360.

FIG. 21 is a flowchart illustrating the data loss period calculation processing according to the second embodiment.

The data loss period calculation processing corresponds to step S34 in FIG. 19 and is executed by the data loss period calculator 225 in the management computer 200.

First, the data loss period calculator 225 searches the indivisible data tail hash value 233b in the journal hash, table 233 with a journal hash value in the journal information received by the journal information receiver 224 (step S101).

Next, the data loss period calculator 225 determines whether a corresponding record is found as a result of the search (step S102).

Accordingly, when the corresponding record has not been found (step S102: No), which indicates that the Write data corresponding to the journal hash value is not the tail Write data of the indivisible data, that is, all the journals of the indivisible data have not been transmitted to the secondary storage system 400, the data loss period calculator 225 ends the processing.

Meanwhile, when the corresponding record is found (step S102: Yes), which indicates that all the journals of the indivisible data corresponding to the record have been transmitted to the secondary storage system 400, the data loss period calculator 225 regards current time point of this time point as a complete time point of writing the indivisible data to the secondary volume (step S103).

Next, the data loss period calculator 225 subtracts, from the complete time point of writing the indivisible data to the secondary volume, the complete time point of writing the indivisible data to the primary volume found in a record of the journal hash table 233 and stored in the complete time point of writing to the primary volume 233a, and regards the obtained period as a data loss period of the indivisible data (step S104).

Next, the data loss period calculator 225 generates a record including the complete time point of writing the indivisible data to the secondary volume and the data loss period of the indivisible data, adds the record to the data loss period table 232 (step S105), and ends the processing.

By the data loss period calculation processing, it is possible to properly determine, based on the hash value, whether ail the journals of the indivisible data have been transmitted to the secondary storage system 400 and accumulate a data loss period for each indivisible data in the data loss period table 232. If the data loss period display portion 226 executes processing similarly to the first embodiment based on the information accumulated in the data loss period table 232, the data loss period display screen 500 can be displayed as shown in FIG. 14. Thus, a management person can understand the data loss period of the indivisible data easily and properly.

While the embodiments of the present invention have been described above, it is to be understood that the present invention is not limited thereto and various modifications can be made without departing from the scope of the invention.

For example, in the first embodiment, when the last journal corresponding to the indivisible data is transmitted to the secondary storage system 400, the journal information transmission program 323 of the primary storage system 300 may transmit, to the management computer 200, the journal information (e.g., the journal information including time point information representing a time point when all the journals are transmitted) representing that all the journals of the indivisible data have been transmitted. In this case, the data loss period calculator 225 of the management computer 200 stores, based on the journal information, the time point When ail the journals corresponding to the indivisible data have been transmitted as the data recoverable time point. In this manner, the management computer 200 can easily determine that all the journals of the indivisible data have been transmitted.

At least one of the logical volumes including the primary volume, the primary journal volume, the secondary journal volume and the secondary volume may be provided as a virtual logical volume (e.g., logical volume complying with a thin provisioning technique or virtualizing a storage source of an external storage system), instead of the substantial logical volume based on the physical storage device included in the storage system.

At least one of the primary journal volume and the secondary journal volume may be replaced by a different type of storage area, such as a partial memory area in the storage system, as a journal storage area.

The management computer 200 may display information by transmitting information to be displayed on a remote computer, instead of displaying information on the display apparatus 250.

### REFERENCE SIGNS LIST

100: host computer
200: management computer
300: primary storage system
400: secondary storage system

1. A computer system, comprising:
a host computer;
a primary storage system coupled to the host computer;
a secondary storage system coupled to the primary storage system; and
a management computer coupled to the host computer and the primary storage system,
wherein the host computer is configured to generate, by executing an application, indivisible data which is a group of data indivisible for maintaining consistency, and to transmit the indivisible data to the secondary storage system,
wherein the primary storage system includes a primary storage controller,
wherein the primary storage controller is configured to
receive and store the indivisible data,
transmit, to the secondary storage system, a plurality of journals each including a plurality of data pieces generated by dividing the indivisible data into predetermined sizes, and
transmit, to the management computer, journal information representing that each of the plurality of journals has been transmitted,
wherein the secondary storage system includes a secondary storage controller,
wherein the secondary storage controller is configured to
receive the plurality of journals, and
store the plurality of data pieces included in each of the plurality of journals, and
wherein the management computer includes:
a journal information receiver configured to receive the journal information from the primary storage system; and
a data loss period calculator configured to determine whether all the journals corresponding to the indivisible data have been transmitted to the secondary storage system and, when it is determined that ail the journals corresponding to the indivisible data have been transmitted to the secondary storage system, store, as a data recoverable time point indicating a time point when recoverable data for the indivisible data is stored, a time point when all the journals corresponding to the indivisible data have been transmitted.

2. The computer system according to claim 1,
wherein the host computer includes an indivisible data information transmitter configured to transmit, to the management computer, indivisible data information including a data size of the indivisible data,
wherein the management computer further includes:
an indivisible data information receiver configured to receive the indivisible data information from the host computer; and
an indivisible data journal number calculator configured to calculate, based on the indivisible data information, the number of journals generated by dividing the indivisible data, and
wherein the data loss period calculator is configured to determine that, by identifying that the calculated number of journals generated by dividing the indivisible data have been transmitted based on the journal information, all the journals corresponding to the indivisible data have been transmitted.

3. The computer system according to claim 2,
wherein the indivisible data information includes an indivisible data storage time point when the indivisible data is stored in the primary storage system,
wherein the data loss period calculator is configured to calculate, as a data loss period, a difference between the indivisible data storage time point of the indivisible data information and the data recoverable time point, and
wherein the management computer further includes a data loss period display portion configured to display information regarding the data loss period.

4. The computer system according to claim 3,
wherein the primary storage system includes a primary volume configured to store the indivisible data,
wherein the secondary storage system includes a secondary volume configured to store the plurality of data pieces included in each of the plurality of journals,
wherein one or more host computers are provided and configured to execute one or more applications, and
wherein the data loss period display portion is configured to display, for each application or volume, the data loss period regarding the plurality of indivisible data pieces associated with the application or the volume in time series.

5. The computer system according to claim 1,
wherein the primary storage controller is configured to delete, from the primary storage system, a journal transmitted to the secondary storage system among the plurality of journals, and
wherein the journal information transmitted to the management computer corresponds to the deleted journal.

6. The computer system according to claim 1,
wherein the primary storage controller is configured to transmit, to the management computer, journal information representing that ail the journals of the indivisible data have been transmitted when the last journal corresponding to the indivisible data is transmitted to the secondary storage system, and
wherein the data loss period calculator is configured to store, as the data recoverable time point, the time point when all the journals corresponding to the indivisible data have been transmitted based on the journal information.

7. The computer system according to claim 1,
wherein the application vises a database system, and
wherein the indivisible data concerns all contents updated in a particular transaction.

8. The computer system according to claim 1,
wherein the application uses a file system, and
wherein the indivisible data is data of a file in the file system.

9. The computer system according to claim 1,
wherein the host computer includes
a management agent portion configured to transmit the indivisible data to the primary storage system by dividing the indivisible data into a plurality of write data pieces having predetermined sizes, calculate a first hash value regarding the last write data piece of the indivisible data, and transmit, to the management computer, indivisible data information including the first hash value and a time point when all the write data pieces constituting the indivisible data have been transmitted to the primary storage system,
wherein, the primary storage controller is configured to
generate a journal including the write data from the host computer,
calculate a second hash value of the write data included in the journal, and
transmit, to the management computer, the journal information including the second hash value of the write data included in the journal when the journal is transmitted to the secondary storage system, and
the data loss period calculator is configured to store, as the data recoverable time point indicating the time point when recoverable data of the indivisible data is stored, a time point when the first hash value of the indivisible data information matches the second hash value of the journal information.

10. The computer system according to claim 9,
wherein the indivisible data information includes the indivisible data storage time point when the indivisible data is stored in the primary storage system,
wherein the data loss period calculator is configured to calculate, as the data loss period, a difference between the indivisible data storage time point of the indivisible data information and the data recoverable time point, and
wherein the management computer further includes a data loss period display portion configured to display information regarding the data loss period.

11. An asynchronous replication management method, comprising:
receiving journal information from a primary storage system, wherein the primary storage system is configured to receive, from a host computer, indivisible data which is a group of data indivisible for maintaining consistency and generated in the host computer by executing an application, store the received indivisible data, and transmit a plurality of journals each including a plurality of data pieces generated by dividing the indivisible data into predetermined sizes, to a secondary storage system configured to receive the plurality of journals and store the plurality of data pieces included in each of the plurality of journals, the primary storage system being configured also to transmit, to the management computer, the journal information representing that each of the plurality of journals has been transmitted;
determining, based on the journal information, whether all journals corresponding to the indivisible data have been transmitted to the secondary storage system; and storing, when it is determined that all the journals corresponding to the indivisible data have been transmitted to the secondary storage system, a time point when all the journals corresponding to the indivisible data have been transmitted as a data recoverable time point indicating a time point when recoverable data of the indivisible data is stored.

12. The asynchronous replication management method according to claim 11, further comprising:
receiving indivisible data information including a data size of the indivisible data from the host computer;
calculating the number of journals generated by dividing the indivisible data based on the indivisible data information; and
determining that all the journals corresponding to the indivisible data have been transmitted by identifying, based on the journal information, that the calculated number of journals generated by dividing the indivisible data have been transmitted.

13. The asynchronous replication management method according to claim 12, wherein the indivisible data information includes an indivisible data storage time point when the indivisible data is stored in the primary storage system,
the method further comprising:
calculating, as a data loss period, a difference between the indivisible data storage time point of the Indivisible data information and the data recoverable time point; and
displaying information regarding the data loss period.

14. The asynchronous replication management method according to claim 13, further comprising
displaying, in time series for each application or volume, the data loss period regarding the plurality of data pieces of the indivisible data associated with the application or the volume,
wherein the primary storage system includes a primary volume configured to store the indivisible data,
wherein the secondary storage system includes a secondary volume configured to store the plurality of data pieces included in each of the plurality of journals, and
wherein one or more host computers are provided and configured to execute one or more applications.

15. The asynchronous replication management method according to claim 11, wherein the received journal information corresponds to a journal deleted by the primary storage system configured to delete, among the plurality of journals, a journal transmitted to the secondary storage system.
